(19) United States
(12) Patent Application Publication
(10) Pub. No.: US 2008/0289697 A1
(43) Pub. Date: Nov. 27, 2008

(54) Water inlet device for mounting a valve body on a deck

(76) Inventor: Ming-Shuan Lin, Taichung Hsien (TW)

Correspondence Address: LADAS & PARRY, 5670 WILSHIRE BOULEVARD, SUITE 2100, LOS ANGELES, CA, 90036-5679, US

(21) Appl. No.: 11/805,441

(22) Filed: May 23, 2007

(51) Int. Cl. F16K 27/00

(52) U.S. Cl. 137/315.12

(57) ABSTRACT

A water inlet device is adapted for mounting a valve body on top of a deck, and includes a fixing unit and a connecting unit including a connecting component that is adapted to be secured to the valve body, and a coupling unit. The coupling unit includes first and second coupling components provided respectively on the fixing unit and the connecting component, and permits rotation of the connecting component relative to the fixing unit between a first position, where the connecting component is separable from the fixing unit, and a second position, where the connecting component is non-separable. One of the first and second coupling components is in a form of a slot having a circumferentially extending segment and a vertically extending segment. The other one is in a form of a protrusion that is extendible into and removable from the slot, when the connecting component is at the first position.

### BACKGROUND OF THE INVENTION

1. Field of the Invention

The invention relates to a tapware, more particularly to a water inlet device for mounting a valve body on a deck.

2. Description of the Related Art

As shown in FIG. 1, a faucet 2 is to be mounted to a deck 1 and includes a valve body 3 that is connected to a water inlet pipe 4. The valve body 3 is formed with a water inlet hole 301 and a screw hole 302. The faucet 2 further includes a threaded securing component 303 and a nut 304. The threaded securing component 303 has one end that engages threadedly the screw hole 302, and an opposite end extending through the deck 1 and engaging the nut 304 so as to secure the faucet 2 to the deck 1. The water inlet pipe 4 has one end fixed in the water inlet hole 301, and an opposite end connected to a control valve 5.

When the faucet 2 is broken and needs to be replaced, a repairman has to close the control valve 5, disconnect the water inlet pipe 4 from the water inlet hole 301 in the valve body 3, loosen the nut 304, and then disconnect the threaded securing component 303 from the screw hole 302. The faucet dismounting operation is performed in a reversed order when installing a new faucet 2 on the deck 1. Therefore, the replacement process is relatively complicated. Moreover, during the process of replacing or installing the faucet 2, the repairman has to operate under the deck 1, which is inconvenient and incurs high labor costs.

### SUMMARY OF THE INVENTION

Therefore, the object of the present invention is to provide a water inlet device for mounting a valve body on a deck, which facilities installation and replacement to result in lower labor costs, and which is able to prevent water from spouting out during replacement.

Accordingly, a water inlet device of the present invention is adapted for mounting a valve body that is formed with a water inlet hole on top of a deck that has a top surface, and is adapted to be connected to a water inlet pipe. The water inlet device comprises a fixing unit and a connecting unit. The fixing unit is adapted to be secured to the top surface of the deck, is formed with a water supply hole corresponding in position to the water inlet hole in the valve body, is adapted for connection to the water inlet pipe, and has a side wall surrounding the water supply hole. The connecting unit is adapted to couple separably the valve body to the fixing unit, and includes a connecting component and a coupling unit. The connecting component is adapted to be secured to the valve body, and is formed with a guide hole to fluidly communicate the water inlet hole in the valve body and the water supply hole in the fixing unit. The coupling unit is for coupling rotatably the connecting component to the fixing unit, and includes first and second coupling components provided on the side wall of the fixing unit and the connecting component, respectively. The second coupling component cooperates with the first coupling component to permit rotation of the connecting component relative to the fixing unit between a first position, where separation of the connecting component from the fixing unit in a vertical direction is permitted, and a second position, where separation of the connecting component from the fixing unit in the vertical direction is prevented. One of the first and second coupling components is in a form of a slot having a circumferentially extending segment, and a vertically extending segment extending from one end of the circumferentially extended segment for access into the circumferentially extending segment. The other one of the first and second coupling components is in a form of a protrusion that is extendible into and removable from said one of the first and second coupling components via the vertically extending segment when the connecting component is at the first position.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded schematic view to illustrate how a faucet is mounted on a deck in the prior art;

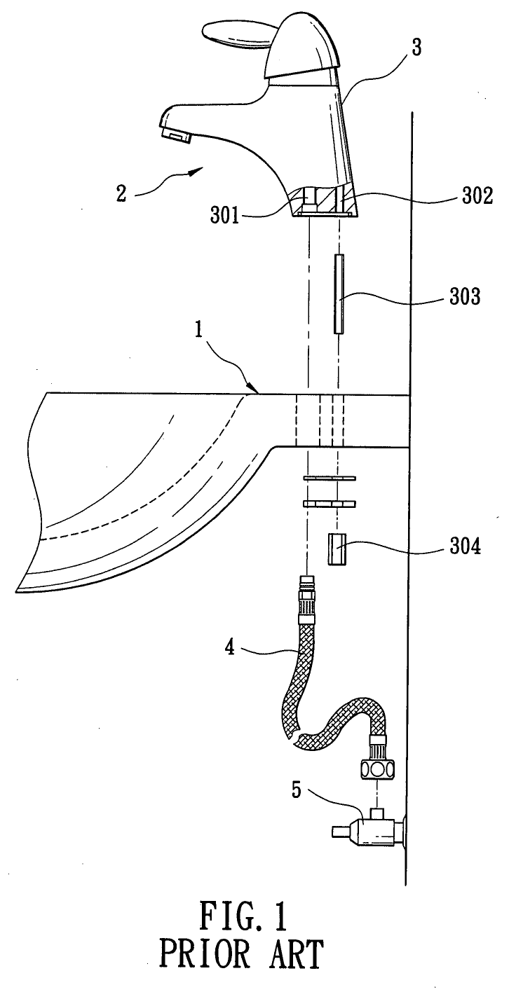

FIG. 2 is an exploded perspective view of a preferred embodiment of a water inlet device according to the invention;

FIG. 3 is an assembled sectional view of the preferred embodiment;

FIG. 4 is an assembled schematic view of the preferred embodiment;

FIG. 5 is a partly exploded sectional view of the preferred embodiment, illustrating a connecting unit separated from a fixing unit;

FIG. 6 is a sectional schematic bottom view of the preferred embodiment taken along line 6-6 in FIG. 3, illustrating a connecting component at a second position;

FIG. 7 is a view similar to FIG. 6, but illustrating the connecting component at a first position;

FIG. 8 is a fragmentary exploded view of the preferred embodiment, illustrating a first coupling component separated from a second coupling component; and

FIG. 9 is a top view of the connecting component.

### DETAILED DESCRIPTION OF THE PREFERRED EMBODIMENT

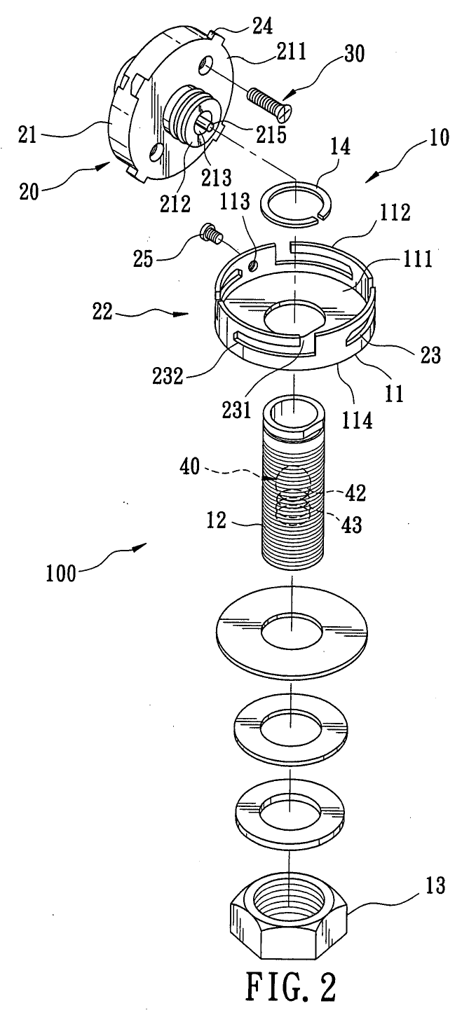

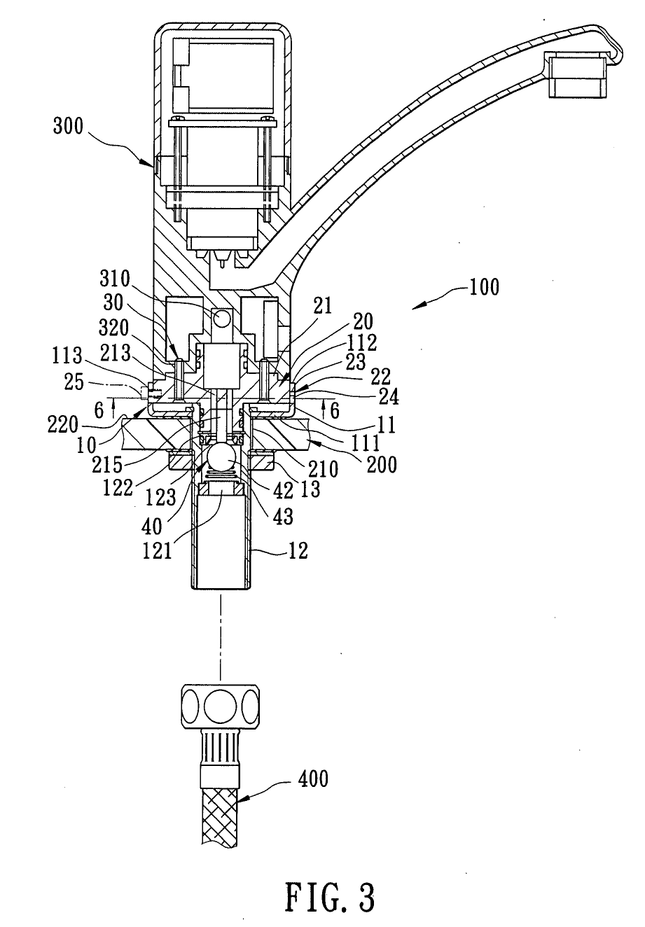

As shown in FIGS. 2 and 3, the preferred embodiment of a water inlet device 100 according to the present invention is adapted for mounting a valve body 300 on top of a deck 200 that has a top surface 220 and a pipe hole 210, and is adapted to be connected to a water inlet pipe 400. The valve body 300 is formed with a water inlet hole 310 that corresponds in position to the pipe hole 210 in the deck 200, and a pair of screw holes 320. The water inlet pipe 400 is connected to a control valve (not shown) in a conventional manner. The water inlet device 100 comprises a fixing unit 10, a connecting unit 20 that is adapted to couple separably the valve body 300 to the fixing unit 10, a pair of screws 30, and a switch unit 40.

The fixing unit 10 includes a fixing plate component 11, a water guide tube 12, a locking collar 13, and a snap ring 14. The fixing plate component 11 is adapted to be secured to the top surface 220 of the deck 200, and has a base plate 111 and having a plate periphery 114, and a side wall 112 extending upwardly from the plate periphery 114 and formed with a positioning screw hole 113. The water guide tube 12 is fastened to the fixing plate component 11 through the snap ring 14, is secured to the deck 200 through the locking collar 13, is formed with a water supply hole 121 that corresponds in position to the water inlet hole 310 in the valve body 300, and that is surrounded by the side wall 112, and is adapted for connection to the water inlet pipe 400. The water guide tube 12 includes a valve seat 122 disposed in the water supply hole 121 and formed with a valve hole 123 that is fluidly communicated with the water supply hole 121.

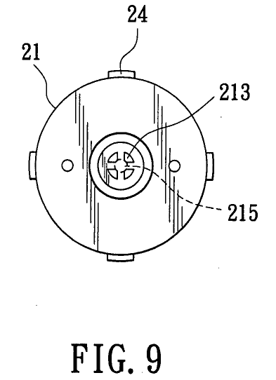

The connecting unit 20 includes a connecting component 21 adapted to be secured to the valve body 300 through the screws 30, a coupling unit 22 for coupling rotatably the connecting component 21 to the fixing unit 10, and a positioning screw 25 extending threadedly through the positioning screw hole 113 in the side wall 112. As further shown in FIG. 9, the connecting component 21 is in a form of a cylindrical block, and has a bottom surface 211 facing the base plate 111, a protruding tube 212 protruding downwardly from the bottom surface 211 and extending tightly into the water supply hole 121 in the fixing unit 10, and a guide hole 213 formed in the protruding tube 212 to fluidly communicate the water inlet hole 310 in the valve body 300 and the water supply hole 121. In this embodiment, the coupling unit 22 includes a plurality of first coupling components 23 provided on the side wall 112, and a plurality of second coupling components 24 provided on the connecting component 21. Each of the first coupling components 23 is in a form of a slot having a circumferentially extending segment 232, and a vertically extending segment 231 extending from one end of the circumferentially extending segment 232 for access into the circumferentially extending segment 232. Each of the second coupling components 24 is in a form of a protrusion.

The switch unit 40 includes a water stopper 42 disposed in the water supply hole 121 in the water guide tube 12 and movable to block and unblock the valve hole 123 in the valve seat 121, and a spring 43 for biasing the water stopper 42 to block the valve hole 123. The connecting component 21 is further provided with a switch actuating rod 215 that extends downwardly from the bottom surface 211 thereof.

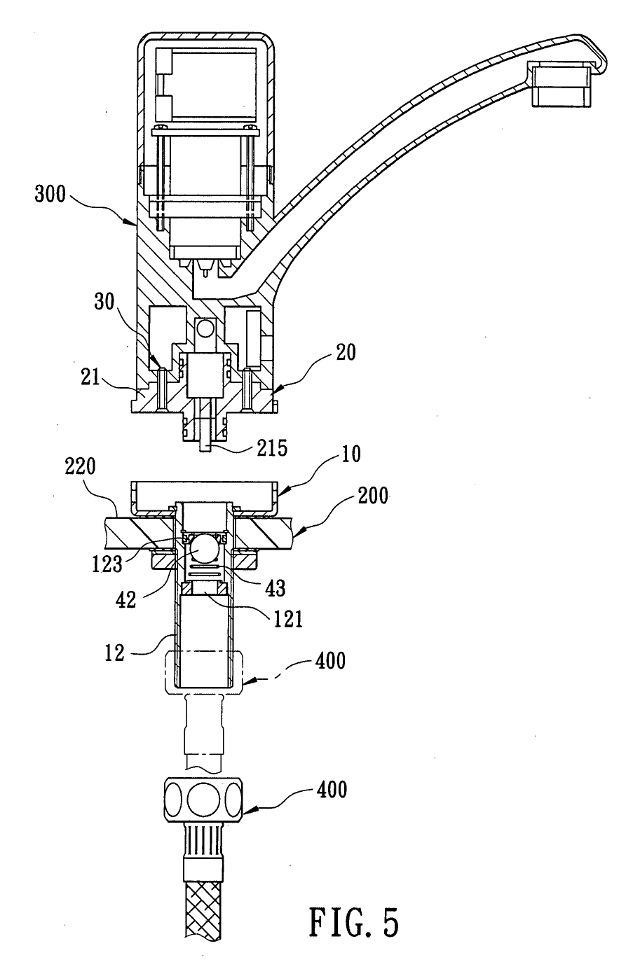

As shown in FIG. 5, installation of the water inlet device 100 of the present invention involves a two-part process. First, the repairman mounts the fixing unit 10 on top of the deck 200, and connects the water inlet pipe 400 to the water guide tube 12 of the fixing unit 10. The second part of the process is to secure the connecting component 21 of the connecting unit 20 to the valve body 300 through the screws 30. This part of the process will be repeated whenever the valve body 300 is to be replaced.

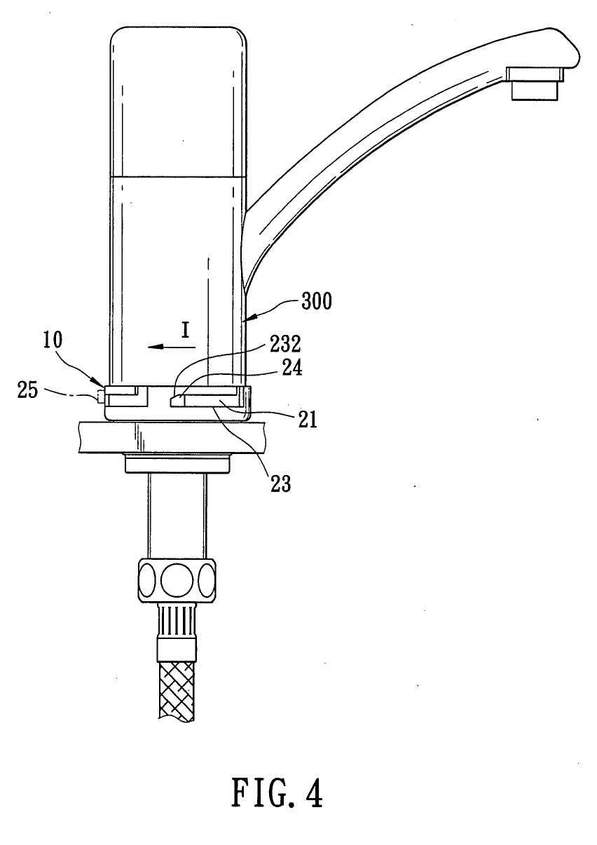

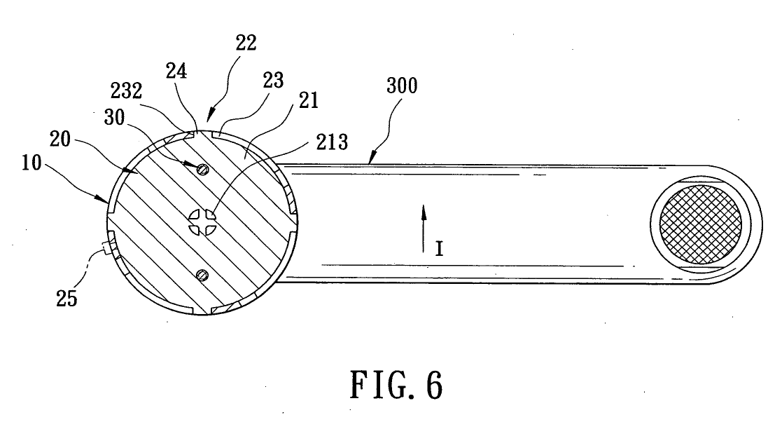

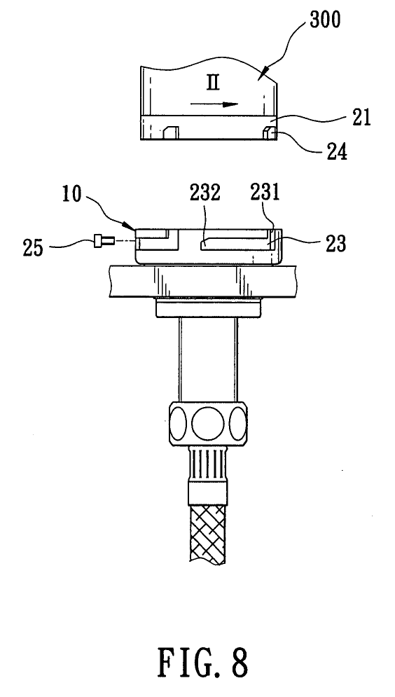

As shown in FIG. 8, to complete installation of the water inlet device 100 of the present invention, the repairman first registers each of the second coupling components 24 with the vertically extending segment 231 of a respective one of the first coupling components 23 and couples the valve body 300 together with the connecting component 21 to the fixing unit 10 at a first position, where each second coupling component 24 is extendible into and removable from the respective first coupling component 23 via the vertically extending segment 231, and where separation of the connecting component 21 from the fixing unit 10 in the vertical direction is permitted. Then, as further shown in FIGS. 4 and 6, the repairman rotates the valve body 300 together with the connecting component 21 along a first direction (I) to a second position, where each of the second coupling components 24 is retained in the circumferentially extending segment 232 of the respective one of the first coupling components 23, and where separation of the connecting component 21 from the fixing unit 10 in the vertical direction is prevented. Finally, the repairman drives the positioning screw 25 to extend threadedly through the positioning screw hole 113 and press against the connecting component 21, so that the valve body 300 is secured to the fixing unit 10. As further shown in FIG. 3, when the fixing unit 10 is coupled to the valve body 300 together with the connecting component 21, the switch actuating rod 215 will push the water stopper 42 to unblock the valve hole 123 in the valve seat 122 against biasing action of the spring 43, so that the valve hole 123 is fluidly communicated with the guide hole 213 and the water supply hole 121.

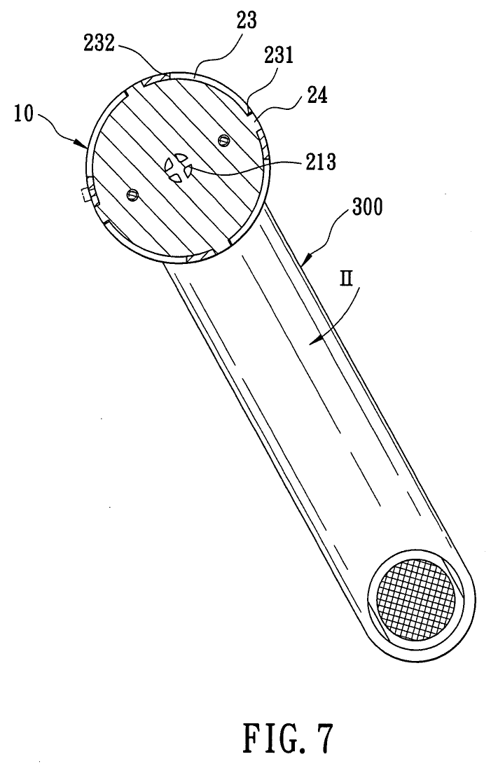

As shown in FIGS. 7 and 8, to replace the valve body 300, the repairman only needs to loosen the positioning screw 25, and rotate the valve body 300 together with the connecting component 21 in a second direction (II) back to the first position. Finally, the repairman pulls the valve body 300 together with the connecting component 21 away from the fixing unit 10. As further shown in FIG. 5, when the valve body 300 together with the connecting component 21 is separated from the fixing unit 10, the switch actuating rod 215 will be withdrawn from the water guide tube 12, so that the water stopper 42 will be released to once again block the valve hole 123 in the valve seat 122 of the fixing unit 10 by virtue of the spring 43, thereby preventing water from spouting out during replacement. Therefore, the process of installing and replacing is made simple by the water inlet device 100 of the present invention. Moreover, once the fixing unit 10 is secured to the deck 200, the repairman no longer has to work under the deck 200 to install or replace the valve body 300, thereby resulting in convenience and lower labor costs.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A water inlet device adapted for mounting a valve body on top of a deck, the valve body being formed with a water inlet hole, the deck having a top surface, said water inlet device being adapted to be connected to a water inlet pipe, said water inlet device comprising:
a fixing unit that is adapted to be secured to the top surface of the deck, that is formed with a water supply hole corresponding in position to the water inlet hole in the valve body, that is adapted for connection to the water inlet pipe, and that has a side wall surrounding said water supply hole; and
a connecting unit that is adapted to couple separably the valve body to said fixing unit, and that includes
a connecting component adapted to be secured to the valve body, and formed with a guide hole to fluidly communicate the water inlet hole in the valve body and said water supply hole in said fixing unit, and
a coupling unit for coupling rotatably said connecting component to said fixing unit, said coupling unit including first and second coupling components provided on said side wall of said fixing unit and said connecting component, respectively,
wherein said second coupling component cooperates with said first coupling component to permit rotation of said connecting component relative to said fixing unit between a first position, where separation of said connecting component from said fixing unit in a vertical direction is permitted, and a second position, where separation of said connecting component from said fixing unit in the vertical direction is prevented,
wherein one of said first and second coupling components is in a form of a slot having a circumferentially extending segment, and a vertically extending segment extending from one end of said circumferentially extending segment for access into said circumferentially extending segment, and
wherein the other one of said first and second coupling components is in a form of a protrusion that is extendible into and removable from said one of said first and second coupling components via said vertically extending segment when said connecting component is at the first position.

2. The water inlet device as claimed in claim 1, wherein said fixing unit includes
a fixing plate component that is adapted to be secured to the top surface of the deck, and that has a base plate adapted to be disposed on the deck and having a plate periphery, said side wall extending upwardly from said plate periphery of said base plate, and
a water guide tube fastened to said fixing plate component and formed with said water supply hole.

3. The water inlet device as claimed in claim 1, further comprising a screw that is adapted to secure said connecting component of said connecting unit to the valve body.

4. The water inlet device as claimed in claim 1, wherein said connecting unit further includes a positioning screw extending threadedly through said side wall of said fixing unit, and pressing against said connecting component of said connecting unit.

5. The water inlet device as claimed in claim 1, wherein said fixing unit is further formed with a valve hole fluidly communicated with said water supply hole,
said water inlet device further comprising a switch unit including a water stopper disposed in said water supply hole and movable to block and unblock said valve hole, and a spring for biasing said water stopper to block said valve hole,
said connecting component of said connecting unit being further provided with a switch actuating rod that extends downwardly and that is disposed to push said water stopper to unblock said valve hole against biasing action of said spring when said connecting component is coupled to said fixing unit.

6. The water inlet device as claimed in claim 1, wherein said first coupling component is in the form of the slot and said second coupling component is in the form of the protrusion.
